(19) United States
(12) Patent Application Publication
(10) Pub. No.: US 2026/0329213 A1
(43) Pub. Date: Oct. 22, 2026

(54) TRANSFER UNIT AND IMAGE FORMING APPARATUS THEREWITH

(71) Applicant: KYOCERA Document Solutions Inc., Osaka (JP)

(72) Inventors: Kazuaki FUJIWARA, Osaka (JP); Keisuke OBA, Osaka (JP)

(73) Assignee: KYOCERA Document Solutions Inc., Osaka (JP)

(21) Appl. No.: 19/468,557

(22) Filed: Feb. 3, 2026

(30) Foreign Application Priority Data
Feb. 6, 2025 (JP) 2025-018047
Oct. 10, 2025 (JP) 2025-171849

(51) Int. Cl. G03G 15/00; G03G 15/16

(52) U.S. Cl. CPC G03G 15/5029; G03G 15/161; G03G 15/1615; G03G 15/162; G03G 15/1665

(57) ABSTRACT

A transfer roller includes a first roller and a second roller different from the first roller. Whichever of the first and second rollers is disposed to face an image carrying member is disposed selectively either at a reference position where it forms a transfer nip portion by being pressed against the image carrying member or at a separated position where it stays away from the image carrying member. According to the thickness or basis weight of a recording medium, either the first roller or the second roller is disposed to face the image carrying member.

### INCORPORATION BY REFERENCE

This application is based on and claims the benefit of priority from Japanese Patent Applications No. 2025-018047 filed on Feb. 6, 2025 and No. 2025-171849 filed on Oct. 10, 2025, the contents of which are hereby incorporated by reference.

### BACKGROUND

The present disclosure relates to a transfer unit that transfers to a recording medium a toner image formed on an image carrying member such as a photosensitive drum and an intermediate transfer belt, and also relates to an image forming apparatus provided with such a transfer unit. More particularly, the present disclosure relates to a mechanism for switching the arrangement of a plurality of transfer members.

With a conventional configuration, depending on the type of recording medium, the conveying load may increase during passage through the transfer nip portion and this may cause transfer failure due to conveying streaks and friction against an image carrying member.

In view of the above problem, an object of the present disclosure is to provide a transfer unit that helps suppress transfer failure according to the type of recording medium, and to provide an image forming apparatus provided with such a transfer unit.

### SUMMARY

To achieve the above objects, according to a first configuration of the present disclosure, a transfer unit includes a transfer roller that has a metal base and an elastic layer laid on the outer circumferential surface of the metal base and that forms a transfer nip portion by pressing the elastic layer against an image carrying member. The transfer unit transfers a toner image formed on the image carrying member to a recording medium passing through the transfer nip portion. The transfer roller includes a first roller and a second roller different from the first roller. Whichever of the first and second rollers is disposed to face the image carrying member is disposed selectively either at a reference position where it forms the transfer nip portion by being pressed against the image carrying member or at a separated position where it stays away from the image carrying member. According to the type of the recording medium, either the first roller or the second roller is disposed to face the image carrying member.

To achieve the above objects, according to a second configuration of the present disclosure, a transfer unit includes a transfer roller that has a metal base and an elastic layer laid on the outer circumferential surface of the metal base and that forms a transfer nip portion by pressing the elastic layer against an image carrying member. The transfer unit transfers a toner image formed on an image carrying member to a recording medium passing through the transfer nip portion. The transfer roller includes a first roller and a second roller having a different linear speed ratio from that of the first roller. Whichever of the first and second rollers is disposed to face the image carrying member is disposed selectively either at a reference position where it forms the transfer nip portion by being pressed against the image carrying member or at a separated position where it stays away from the image carrying member. According to the thickness or basis weight of the recording medium, either the first roller or the second roller is disposed to face the image carrying member.

Further objects of the present disclosure and specific advantages achieved according to the present disclosure become more apparent from the following description of the embodiment.

### BRIEF DESCRIPTION OF THE DRAWINGS

FIG. 1 is a schematic diagram showing the interior construction of an image forming apparatus 100 provided with a secondary transfer unit 9 according to the present disclosure.

FIG. 2 is an enlarged view around an image forming portion Pa in FIG. 1.

FIG. 3 is a side sectional view of an intermediate transfer unit 30 incorporated in the image forming apparatus 100.

FIG. 4 is a perspective view of the secondary transfer unit 9 according to one embodiment of the present disclosure that is incorporated in the image forming apparatus 100.

FIG. 5 is an enlarged perspective view showing the configuration of a roller holder 47 in the secondary transfer unit 9 of the embodiment.

FIG. 6 is a perspective view, as seen from axially inward, around the roller holder 47 in the secondary transfer unit 9.

FIG. 7 is a perspective view showing a drive mechanism of the secondary transfer unit 9 of the embodiment.

FIG. 8 is a block diagram showing one example of control paths in the image forming apparatus 100 that incorporates the secondary transfer unit 9 of the embodiment.

FIG. 9 is a side sectional view around a switching cam 50 in the secondary transfer unit 9 of the embodiment, showing a state, as seen from axially inward, where a first roller 40 is disposed at a reference position where it forms a secondary transfer nip portion N.

FIG. 10 is a diagram showing a state where, from the state in FIG. 9, the switching cam 50 has been removed to expose a fixed cam 52.

FIG. 11 is a diagram showing a separated state of the first roller 40 where, from the

state in FIG. 9, the switching cam 50 has been rotated counterclockwise by a predetermined angle.

FIG. 12 is a diagram showing a state where, from the state in FIG. 11, the switching cam 50 has been rotated further counterclockwise by a predetermined angle so that a second roller 41 is disposed to face a driving roller 10.

FIG. 13 is a diagram showing a state where, from the state in FIG. 12, the switching cam 50 has been rotated clockwise by a predetermined angle so that the second roller 41 is disposed at a reference position where it forms the secondary transfer nip portion N.

FIG. 14 is a diagram showing a separated state of the second roller 41 where, from the state in FIG. 13, the switching cam 50 has been rotated further counterclockwise by a predetermined angle.

FIG. 15 is a side view showing a state where a metal base 40a of the first roller 40 disposed at the reference position, where it forms the secondary transfer nip portion N, is fitted into a shaft holding portion 37 of the intermediate transfer unit 30.

FIG. 16 is a side view showing a state where a first engaging portion 43a of a first bearing member 43 is not engaged with a positioning groove 66 in the fixed cam 52 and the metal base 40a of the first roller 40 is displaced from the shaft holding portion 37.

FIG. 17 is a perspective view, as seen from the side facing the roller holder 47, of the fixed cam 52 used in the secondary transfer unit 9 of the embodiment.

FIG. 18 is a perspective view, as seen from the side facing the fixed cam 52, of the roller holder 47 used in the secondary transfer unit 9 of the embodiment.

FIG. 19 is a perspective view, as seen from radially inward, of a state where a holder positioning protruding portion 67 on the fixed cam 52 is engaged with a holder positioning depressed portion 68 in the roller holder 47.

### DETAILED DESCRIPTION

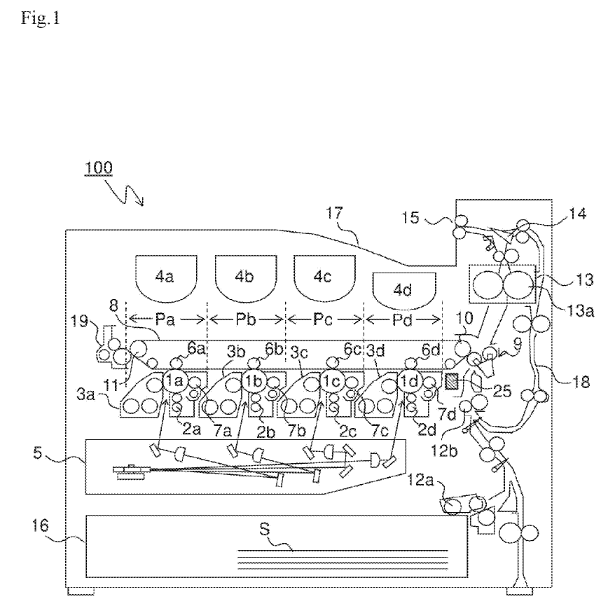

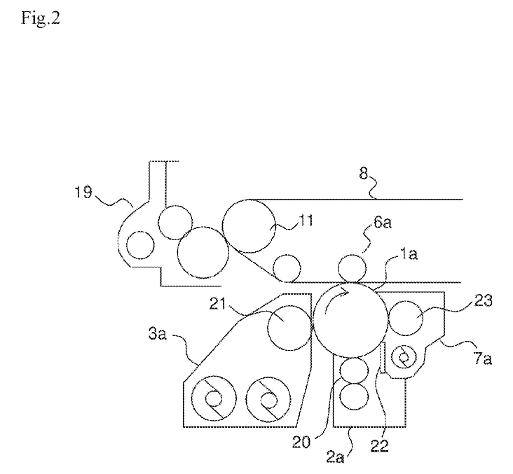

An embodiment of the present disclosure will be described below with reference to the accompanying drawings. FIG. 1 is a schematic diagram showing the construction of an image forming apparatus 100 provided with a secondary transfer unit 9 according to the present disclosure. FIG. 2 is an enlarged view around an image forming portion Pa in FIG. 1.

The image forming apparatus 100 in FIG. 1 is what is called a tandem-type color printer and has the configuration described below. In the body of the image forming apparatus 100, four image forming portions Pa, Pb, Pc, and Pd are arranged in this order from upstream (left side in FIG. 1) along the conveying direction. These image forming portions Pa to Pd are provided for images of four different colors (magenta, cyan, yellow, and black) and sequentially form a magenta, a cyan, a yellow, and a black image respectively, each through the processes of electrostatic charging, exposure to light, image development, and image transfer.

These image forming portions Pa to Pd are provided with photosensitive drums 1a, 1b, 1c, and 1d that carry visible images (toner images) of the corresponding colors. Furthermore, an intermediate transfer belt 8 that rotates counterclockwise in FIG. 1 is provided adjacent to these image forming portions Pa to Pd. The toner images formed on these photosensitive drums 1a to 1d are transferred sequentially to the intermediate transfer belt (image carrying member) 8, which moves while in contact with the photosensitive drums 1a to 1d, and are then transferred all at once to a sheet (recording medium) S as one example of a recording medium in the secondary transfer unit (transfer unit) 9.

The sheet S then has the toner images fixed to it in a fixing portion 13 and is then discharged out of the body of the image forming apparatus 100. While the photosensitive drums 1a to 1d are rotated clockwise in FIG. 1, an image forming process is performed for each of them.

The sheet S to which the toner images are to be transferred is stored in a sheet storage cassette 16 disposed in a lower part of the body of the image forming apparatus 100. The sheet S is conveyed to the secondary transfer unit 9 via a sheet feed roller 12a and a pair of registration rollers 12b. Used as the intermediate transfer belt 8 is typically a belt with no seams (seamless belt).

Next, a description will be given of the image forming portions Pa to Pd. While the image forming portion Pa will be described in detail below, the image forming portions Pb to Pd share the same basic configuration and thus their description will be omitted. As shown in FIG. 2, around the photosensitive drums 1a, along its rotational direction (clockwise in FIG. 2), there are provided a charging device 2a, a developing device 3a, a primary transfer roller 6a across the intermediate transfer belt 8, and a cleaning device 7a.

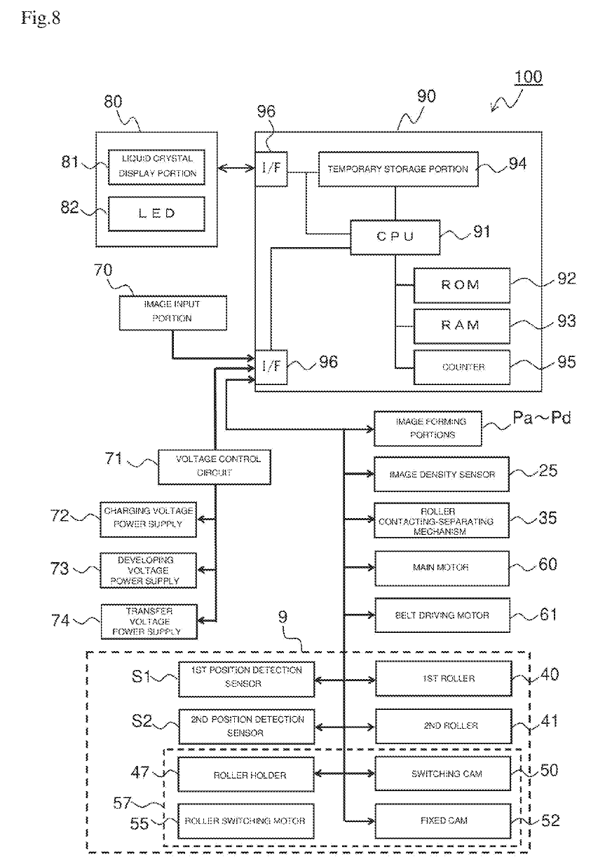

Next, a description will be given of the procedure for image formation in the image forming apparatus 100. When the user enters a command to start image formation, first, a main motor 60 (see FIG. 8) starts rotating the photosensitive drums 1a to 1d and the surfaces of the photosensitive drums 1a to 1d are electrostatically charged uniformly by a charging roller 20 in the charging devices 2a to 2d. Next, a light beam (laser light) emitted from an exposure device 5 is shone onto the photosensitive drums 1a to 1d to form on them electrostatic latent images corresponding to an image signal.

The developing devices 3a to 3d are loaded with predetermined amounts of toner of the colors magenta, cyan, yellow, and black. When the proportion of toner in the two-component developer in the developing devices 3a to 3d falls below a prescribed amount as toner images are formed as will be described later, toner is supplied from toner containers 4a to 4d to the developing devices 3a to 3d. The toner in the developer is supplied to the photosensitive drums 1a to 1d by a developing roller 21 in the developing devices 3a to 3d and attaches to them electrostatically. This forms toner images corresponding to the electrostatic latent images formed by exposure to light from the exposure device 5.

Then, primary transfer rollers6a to 6d produce electric fields with a predetermined transfer voltage between themselves and the photosensitive drums 1a to 1d, and the magenta, cyan, yellow, and black toner images on the photosensitive drums 1a to 1dare primarily transferred to the intermediate transfer belt 8. These four-color images are formed in a predetermined positional relationship previously determined to form a predetermined full-color image. After that, in preparation for the subsequent formation of new electrostatic latent images, the toner remaining on the surfaces of the photosensitive drums 1a to 1d is removed by a cleaning blade 22 and a rubbing roller 23 in the cleaning devices 7a to 7d.

When the intermediate transfer belt 8 starts to rotate counterclockwise as a belt driving motor 61 (see FIG. 8) rotates the driving roller 10, a sheet S is conveyed, with predetermined timing, from the pair of registration rollers 12b to the secondary transfer unit 9 provided adjacent to the intermediate transfer belt 8 to have the toner images transferred to it. The sheet S having the toner images transferred to it is conveyed to the fixing portion 13. The toner remaining on the surface of the intermediate transfer belt 8 is removed by a belt cleaning unit 19.

The sheet S conveyed to the fixing portion 13 is heated and pressed by a pair of fixing rollers 13a to have the toner images fixed to its surface. The sheet S having the toner images fixed to it has its conveying direction switched by a branch portion 14 which branches into multiple directions and is then discharged by a pair of discharging rollers 15 to a discharge tray 17 as it is (or after being sent to a duplex conveying passage 18 to have images printed on both sides).

An image density sensor 25 is disposed at a position facing the intermediate transfer belt 8 downstream of the image forming portion Pd. Used as the image density sensor 25 is generally an optical sensor comprising a light emitting element such as an LED and a light receiving element such as a photodiode. When the amount of toner adhered to the intermediate transfer belt 8 is measured, shining measurement light from the light emitting element to patch images (reference images) formed on the intermediate transfer belt 8 results in the measurement light striking the light receiving element as light reflected from the toner and light reflected from the surface of the belt.

The light reflected from the toner and the surface of the belt includes specularly reflected light and diffusely reflected light. The specularly and diffusely reflected light are split by a polarizing splitter prism and then each enter a separate light receiving element. The light receiving element photoelectrically converts the received specularly and diffusely reflected light, and outputs an output signal to a control portion 90 (see FIG. 8).

Then, based on the change of the characteristics of the output signals representing the specularly and diffusely reflected light, the image density (amount of toner) and the image position of the patch images are detected and compared with a reference density and a reference position previously determined, to adjust the characteristic value of the development voltage, the start position and the timing of exposure by the exposure device 5, and the like. In this way, density correction and color shift correction are performed for each color.

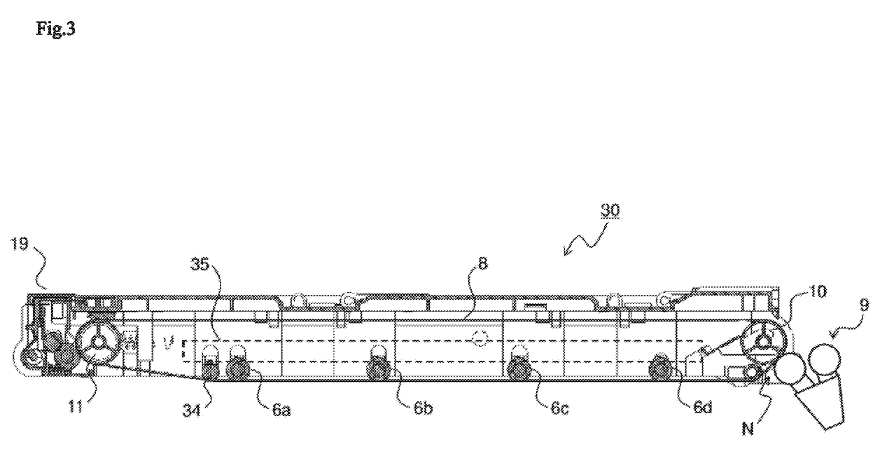

FIG. 3 is a side sectional view of an intermediate transfer unit 30 incorporated in the image forming apparatus 100. As shown in FIG. 3, the intermediate transfer unit 30 has the intermediate transfer belt 8 stretched across the driving roller 10 and a tension roller 11, the primary transfer rollers 6a to 6d in contact with the photosensitive drums 1a to 1d via the intermediate transfer belt 8, and a pressure switching roller 34.

The belt cleaning unit 19 for removing the toner remaining on the surface of the intermediate transfer belt 8 is disposed at a position facing the tension roller 11. The driving roller 10 is provided with the secondary transfer unit 9 across the intermediate transfer belt 8 to form a secondary transfer nip portion N. The configuration of the secondary transfer unit 9 will be described in detail later.

The intermediate transfer unit 30 includes a pair of support members (not illustrated) that rotatably supports opposite end parts of the rotational shafts of the primary transfer rollers 6a to 6d and the pressure switching roller 34 such that these are vertically movable relative to the direction of travel of the intermediate transfer belt 8 (i.e. the top-bottom direction in FIG. 3). The intermediate transfer unit 30 also includes a roller contacting-separating mechanism 35 that has a driving means (not illustrated) for reciprocating in the top-bottom direction the primary transfer rollers 6a to 6d and the pressure switching roller 34. The roller contacting-separating mechanism 35 can be switched among a color mode in which the four primary transfer rollers 6a to 6d are pressed against the photosensitive drums 1a to 1d (see FIG. 1) across the intermediate transfer belt 8, a monochrome mode in which only the primary transfer roller 6d is pressed against the photosensitive drum 1d across the intermediate transfer belt 8, and a retraction mode in which the four primary transfer rollers 6a to 6d are kept away from the photosensitive drums 1a to 1d.

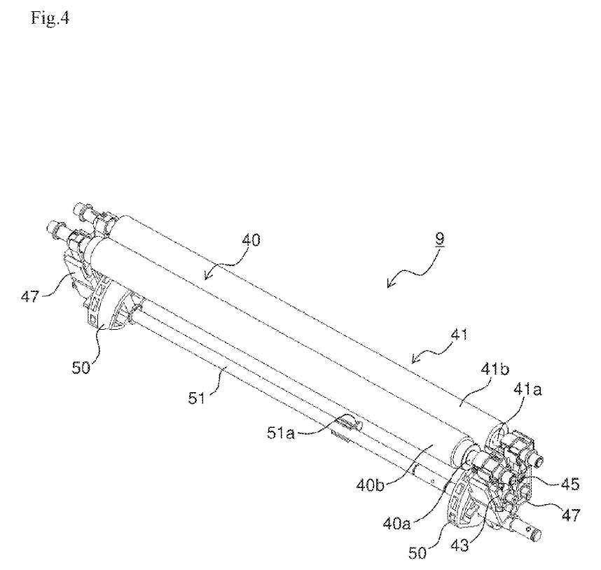

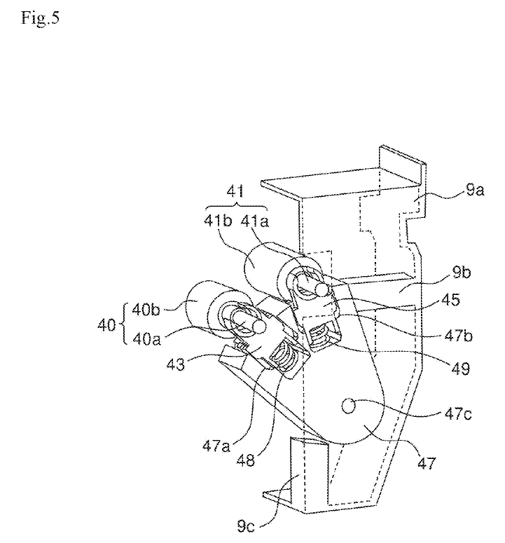

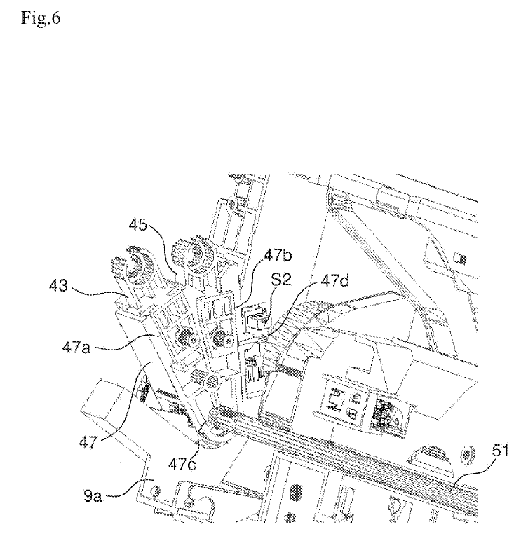

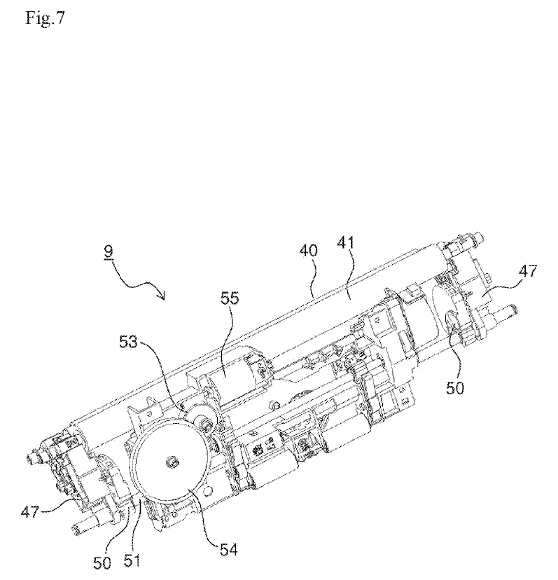

FIG. 4 is a perspective view of the secondary transfer unit 9 according to one embodiment of the present disclosure that is incorporated in the image forming apparatus 100. FIG. 5 is an enlarged perspective view showing the configuration, at one end side, of the secondary transfer unit 9 of the embodiment. FIG. 6 is a perspective view around a roller holder 47 in the secondary transfer unit 9, as seen from axially inward. FIG. 7 is a perspective view showing a drive mechanism of the secondary transfer unit 9 of the embodiment. FIGS. 4 and 7 omit illustration of a unit frame 9a, and FIG. 5 shows the unit frame 9a as see-through. FIGS. 5 and 6 omit illustration of a switching cam 50 and a fixed cam 52, and FIGS. 4 and 7 omit illustration of the fixed cam 52.

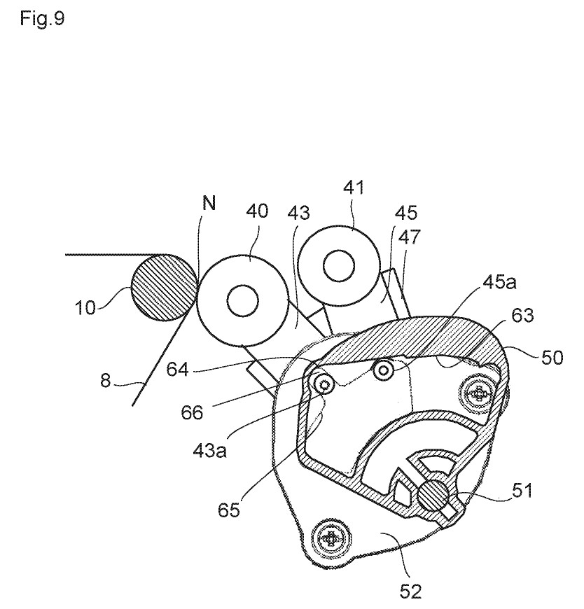

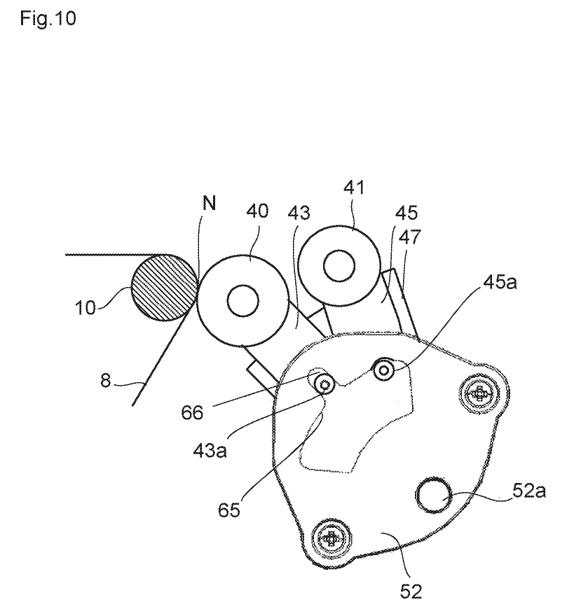

As shown in FIGS. 4 to 7, the secondary transfer unit 9 includes a first roller 40 and a second roller 41 that together constitute a secondary transfer roller (transfer roller), a first bearing member 43, a second bearing member 45, the roller holder 47, the switching cam 50, the fixed cam 52 (see FIGS. 9 and 10), and a roller switching motor (drive mechanism) 55.

The first and second rollers 40 and 41 are elastic rollers that have conductive elastic layers 40b and 41b laid on the outer circumferential surfaces of metal bases 40a and 41a, respectively. Used as the material of the elastic layers 40b and 41b is, for example, ion-conductive rubber such as ECO (epichlorohydrin rubber).

In the embodiment, the first and second rollers 40 and 41 have different shapes and one of them is used depending on the thickness or basis weight of the sheet (recording medium) S. In the embodiment, the outer diameter of the metal base 41a of the second roller 41 is larger than that of the metal base 40a of the first roller 40. Furthermore, the outer diameter of the elastic layer 41b of the second roller 41 is larger than that of the elastic layer 40b of the first roller 40.

Furthermore, the axial length of the elastic layer 41b of the second roller 41 is larger than that of the elastic layer 40b of the first roller 40. In the embodiment, the elastic layer 40b of the first roller 40 has an axial length of 311mm, which corresponds to an A3 size sheet. The elastic layer 41b of the second roller 41 has an axial length of 325mm, which corresponds to a 13-inch size sheet.

The first bearing member 43 rotatably supports the first roller 40. The second bearing member 45 rotatably supports the second roller 41. More specifically, a pair of first bearing members 43 are disposed at opposite end parts of the first roller 40 along the axial direction so as to rotatably support the metal base 40a. A pair of second bearing members 45 are disposed at opposite end parts of the second roller 41 along the axial direction so as to rotatably support the metal base 41a.

A pair of roller holders 47 are disposed at opposite end parts of the first and second rollers 40 and 41 along the axial direction. The roller holder 47 is substantially V-shaped as seen in a side view and has a first bearing holding portion 47a, a second bearing holding portion 47b, and a through hole 47c (see FIG. 5). The first bearing holding portion 47a holds the first bearing member 43 so that it can slide toward and away from the intermediate transfer belt (image carrying member) 8. The second bearing holding portion 47b holds the second bearing member 45 so that it can slide toward and away from the intermediate transfer belt (image carrying member) 8. The through hole 47c is formed in an apical part of the V-shape, and a shaft 51 is rotatably inserted through it. The roller holder 47 is formed of an insulating material such as synthetic resin.

A first coil spring (first urging member) 48 is disposed between the first bearing holding portion 47a and the first bearing member 43 (see FIG. 5). A second coil spring (second urging member) 49 is disposed between the second bearing holding portion 47b and the second bearing member 45. The first roller 40 is urged by the first coil spring 48 and the second roller 41 is urged by the second coil spring 49, each in a direction away from the shaft 51 (in a direction in which they are pressed against the driving roller 10).

As a result, the first coil spring (first urging member) 48 urges the first bearing member 43 in a direction toward the intermediate transfer belt (image carrying member) 8. The second coil spring (second urging member) 49 urges the second bearing member 45 in a direction toward the intermediate transfer belt (image carrying member) 8.

In the embodiment, the load of the second coil spring (second urging member) 49 is higher than that of the first coil spring (first urging member) 48.

A first light-blocking plate 51a is attached to the shaft 51 (see FIG. 4); by blocking light to a detection portion of a first position detection sensor S1 (see FIG. 8), it permits detection of the rotational angle of the shaft 51. Furthermore, a second light-blocking plate 47d is formed on one side face of the roller holder 47 along its rotational direction (see FIG. 6). The second light-blocking plate 47d is formed at a position where it can block light to a detection portion of the second position detection sensor S2 disposed on the unit frame 9a.

According to the rotational angle of the roller holder 47 (shaft 51), the first and second light-blocking plates 51a and 47d turn on or off the first and second position detection sensors S1 and S2. This makes it possible to detect the positions of the first and second rollers 40 and 41 supported on the roller holder 47. The control for the detection of the position of the first and second rollers 40 and 41 will be described later.

A pair of switching cams 50 are disposed inward of the roller holder 47 at opposite end parts of the first and second rollers 40 and 41 along the axial direction (see FIG. 4). The switching cam 50 has a partially cut-out fan shape as seen in a side view, and a pivot part of the fan (a vertex part where two radii intersect) is fixed to the shaft 51.

A roller switching motor 55 is coupled to the shaft 51 via gears 53 and 54 (see FIG. 7). Rotating the switching cam 50 together with the shaft 51 switches the arrangement of the first and second rollers 40 and 41. The control for switching between the first and second rollers 40 and 41 will be described later.

FIG. 8 is a block diagram showing one example of control paths in the image forming apparatus 100 that incorporates the secondary transfer unit 9 of the embodiment. Since various kinds of control are performed on different parts of the image forming apparatus 100 in use, the control paths in the entire image forming apparatus 100 are complicated. For simplicity’s sake, the description here will focus on those control paths that are necessary for the implementation of the present disclosure.

The control portion 90 includes at least a CPU (central processing unit) 91 as a central arithmetic processor, a ROM (read-only memory) 92 as a read-only storage, a RAM (random access memory) 93 as a readable-writable storage, a temporary storage portion 94 for temporarily storing image data, a counter 95, and a plurality of (here, two) I/Fs (interfaces) 96 for transmitting control signals to different devices in the image forming apparatus 100 and receiving input signals from an operation portion 80. The control portion 90 can be disposed at any location in the main body of the image forming apparatus 100.

The ROM 92 stores data and the like that are not changed during the use of the image forming apparatus 100, such as control programs for the image forming apparatus 100 and numerical values required for control. The RAM 93 stores necessary data generated during the control of the image forming apparatus 100, data temporarily required for the control of the image forming apparatus 100, and the like. The RAM 93 (or ROM 92) also stores a density correction table used for calibration and a relationship between the on-off states of the first and second position detection sensors S1 and S2 and the rotational angles of the first and second rollers 40 and 41, for use in roller switching control, which will be described later. The counter 95 counts the number of printed sheets cumulatively.

The control portion 90 transmits control signals from the CPU 91 to different parts and devices in the image forming apparatus 100 via the I/Fs 96. Furthermore, from those different parts and devices, signals indicating their states and also input signals are transmitted to the CPU 91 via the I/Fs 96. The parts and devices controlled by the control portion 90 include, for example, the image forming portions Pa to Pd, the exposure device 5, the primary transfer rollers 6a to 6d, the secondary transfer unit 9, the roller contacting-separating mechanism 35, the main motor 60, the belt driving motor 61, an image input portion 70, a voltage control circuit 71, and the operation portion 80.

The image input portion 70 is a receiving portion that receives image data transmitted to the image forming apparatus 100 from a host device such as a personal computer. An image signal input from the image input portion 70 is converted to a digital signal and is then fed to the temporary storage portion 94.

The voltage control circuit 71 is connected to a charging voltage power supply 72, a developing voltage power supply 73, and a transfer voltage power supply 74, and operates these power supplies based on output signals from the control portion 90. Based on control signals from the voltage control circuit 71, predetermined voltages are applied respectively from the charging voltage power supply 72 to the charging rollers 20 in the charging devices 2a to 2d, from the developing voltage power supply 73 to the developing rollers 21 in the developing devices 3a to 3d, and from the transfer voltage power supply 74 to the primary transfer rollers 6a to 6d and to the first and second rollers 40 and 41 in the secondary transfer unit 9.

The operation portion 80 is provided with a liquid crystal display portion 81 and LEDs 82 that indicate various states. The user operates a stop-clear button on the operation portion 80 to stop image formation and operates a reset button to reset various settings on the image forming apparatus 100 to their default states. The liquid crystal display portion 81 indicates the status of the image forming apparatus 100. It also indicates the progress of image formation and the number of printed sheets. Various settings for the image forming apparatus 100 are made via a printer driver on a personal computer.

FIG. 9 is a side sectional view around the switching cam 50 in the secondary transfer unit 9 of the embodiment, showing a state where the first roller 40 is disposed at a position where it forms the secondary transfer nip portion N, as seen from axially inward. FIG. 10 is a diagram showing a state where, from the state in FIG. 9, the switching cam 50 has been removed to expose the fixed cam 52.

As shown in FIG. 9, the switching cam 50 is, as seen in a plan view, in a fan shape. The switching cam 50 has a first guide hole 63 in an arc shape. The first guide hole 63 engages with a first engaging portion 43a formed on the first bearing member 43 and a second engaging portion 45a formed on the second bearing member 45.

The first guide hole 63 has a depressed portion 64. The depressed portion 64 is formed with a radially outer circumferential part of the first guide hole 63 depressed further radially outward, and extends from the middle of the radially outer circumferential part of the first guide hole 63 along the circumferential direction to one side (the left side in FIG. 9) along the circumferential direction.

As the switching cam 50 rotates, the first and second engaging portions 43a and 45a are disposed either in the depressed portion 64 or away from the depressed portion 64. This permits the switching of the contact state of the first and second rollers 40 and 41 with the intermediate transfer belt 8.

The fixed cam 52 is disposed between the roller holder 47 and the switching cam 50 and is fixed to the unit frame 9a of the secondary transfer unit 9 with screws (see FIG. 10).

The fixed cam 52 has a through hole 52a, a second guide hole 65 in an arc shape, and a positioning groove 66. The shaft 51 is rotatably inserted in the through hole 52a.

The second guide hole 65 is formed at a position where it overlaps with the first guide hole 63 in the switching cam 50 and engages with the first and second engaging portions 43a and 45a.

The positioning groove 66 engages with the first engaging portion 43a when the first roller 40 is disposed to face the driving roller 10, and engages with the second engaging portion 45a when the second roller 41 is disposed to face the driving roller 10.

In the embodiment, the positioning groove 66 is formed with a radially outer circumferential part of the second guide hole 65 depressed radially outward from the middle of it along the circumferential direction. The circumferential dimension (groove width) of the positioning groove 66 is slightly larger than the outer diameter of the first and second engaging portions 43a and 45a.

In the state shown in FIG. 9, the first engaging portion 43a of the first bearing member 43 is engaged with the depressed portion 64. This permits the first roller 40 to be pressed against the driving roller 10 via the intermediate transfer belt 8 under the urging force of the first coil spring 48 (see FIG. 5), to form the secondary transfer nip portion (transfer nip portion) N. At this time, the first roller 40 does not follow the driving roller 10 and rotates at a predetermined rotational speed. A transfer voltage with the opposite polarity (here, negative polarity) to that of toner is applied to the first roller 40 by the transfer voltage power supply 74 (see FIG. 8). Specifically, with the first roller 40 disposed at the position shown in FIG. 9, the transfer voltage is applied to it via the first bearing member 43, which is electrically connected to the transfer voltage power supply 74.

The first light-blocking plate 51a on the shaft 51 (see FIG. 4) blocks light (turns on) to the detection portion of the first position detection sensor S1. The second light-blocking plate 47d on the roller holder 47 (see FIG. 6) blocks light (turns on) to the detection portion of the second position detection sensor S2. This state (S1/S2 on) is taken as the reference position (home position) of the first roller 40. Based on the rotational time of the switching cam 50 from this reference position, the rotational angle of the switching cam 50 is regulated to control the position and a separated state of the first roller 40.

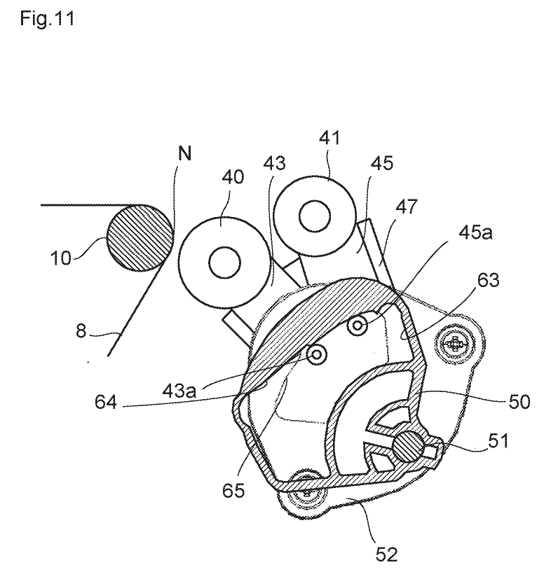

Next, with reference to FIGS. 11 - 15, and also FIGS. 4 - 10 as needed, a description will be given of the control for switching, and for the detection of the position of, the first and second rollers 40 and 41 in the secondary transfer unit 9 of the embodiment.

FIG. 11 is a diagram showing a state where, from the state in FIG. 9, the switching cam 50 has been rotated counterclockwise by a predetermined angle. When the shaft 51 is rotated counterclockwise, together with it the switching cam 50 also rotates. Meanwhile, the first engaging portion 43a moves from a bottom part of the depressed portion 64 across the inclined surface of the depressed portion 64. The first bearing member 43 moves in the positioning groove 66 in a direction toward the shaft 51 against the urging force of the first coil spring 48 (see FIG. 5). When the first engaging member 43a moves out of the depressed portion 64, it disengages from the positioning groove 66. Now, the first roller 40 is away from the intermediate transfer belt 8 (separated state).

As the switching cam 50 rotates, the second engaging portion 45a moves across the inclined surface of the depressed portion 64. Meanwhile, the second bearing member 45 moves in a direction toward the shaft 51 against the urging force of the second coil spring 49 (see FIG. 5). The roller holder 47 disengages from the fixed cam 52.

If the first roller 40 is kept in pressed contact with the driving roller 10 for a long time, the first roller 40 may deform by warping along its axial direction. To cope with that, after a job is complete, it is necessary to keep the first roller 40 away from the intermediate transfer belt 8 (driving roller 10). For that purpose, the separated state shown in FIG. 11 is taken.

The first light-blocking plate 51a on the shaft 51 retracts from the detection portion of (turns off) the first position detection sensor S1, while the second light-blocking plate 47d on the roller holder 47 keeps blocking light to the detection portion of (keeps on) the second position detection sensor S2. That is, a shift from the detection state in FIG. 9 (S1/S2 on) to the detection state in FIG. 11 (S1 off/S2 on) permits the detection of the movement of the first roller 40 from the reference position to the separated state.

On the other hand, to return the first roller 40 from the separated state to its reference position, the roller holder 47 and the switching cam 50 are rotated clockwise. Meanwhile, the roller holder 47 is restrained from rotating clockwise by a restricting rib 9b (see FIG. 5). As a result, the first and second engaging portions 43a and 45a move into the depressed portion 64 to engage each with the positioning groove 66.

Next, a description will be given of the procedure for switching the roller forming the secondary transfer nip portion N from the first roller 40 to the second roller 41. If the shaft 51 is rotated counterclockwise from the separated state shown in FIG. 11, together with it, the switching cam 50 also rotates counterclockwise. Meanwhile, the first bearing member 43 is urged in a direction away from the shaft 51 under the urging force of the first coil spring 48. The second bearing member 45 is also urged in a direction away from the shaft 51 under the urging force of the second coil spring 49. This permits the first and second engaging portions 43a and 45a to be pressed against the radially outer circumferential part of the first guide hole 63 in the switching cam 50. Accordingly, the roller holder 47 rotates counterclockwise together with the switching cam 50.

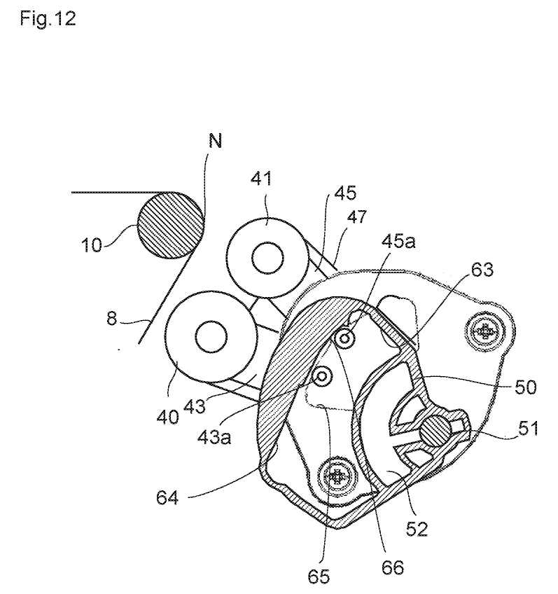

Then, when the roller holder 47 rotates until it makes contact with a restricting rib 9c (see FIG. 5), the second roller 41 is disposed at a position where it faces the driving roller 10 as shown in FIG. 12. At this time, part of the second engaging portion 45a enters the open end of the positioning groove 66. In the state in FIG. 12, the first light-blocking plate 51a on the shaft 51 is retracted from the detection portion of (keeps off) the first position detection sensor S1, and the second light-blocking plate 47d on the roller holder 47 is retracted from the detection portion of (turns off) the second position detection sensor S2. That is, a shift from the detection state in FIG. 11 (S1 off / S2 on) to the detection state in FIG. 12 (S1/S2 off) permits the detection of the movement of the second roller 41 to a position facing the driving roller 10.

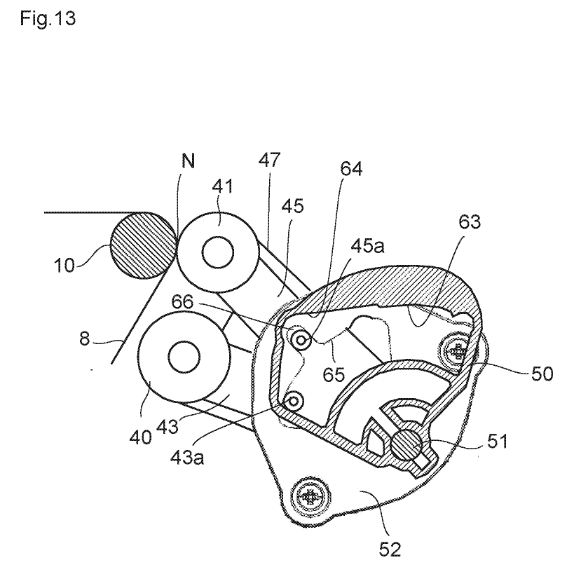

FIG. 13 is a diagram showing a state where, from the state in FIG. 12, the switching cam 50 has been rotated clockwise by a predetermined angle. As the shaft 51 is rotated clockwise, together with it, the switching cam 50 also rotates. On the other hand, since part of the second engaging portion 45a is in the open end of the positioning groove 66 and is engaged with it, the roller holder 47 is restrained from rotating clockwise. Accordingly, only the switching cam 50 rotates clockwise. The second bearing member 45 is acted on in a direction away from the shaft 51 under the urging force of the second coil spring 49 (see FIG. 5). As a result, the second engaging portion 45a gradually moves toward the bottom of the positioning groove 66 while sliding across the radially outer circumferential part of the first guide hole 63.

When the second engaging portion 45a reaches the bottom part 64a of the depressed portion 64, under the urging force of the second coil spring 49 (see FIG. 5), the second roller 41 is pressed against the driving roller 10 via the intermediate transfer belt 8 to form the secondary transfer nip portion N. Meanwhile, the second roller 41 does not follow the driving roller 10 and rotates a predetermined rotational speed. In the embodiment, the linear speed ratio of the second roller 41 to the intermediate transfer belt (image carrying member) 8 is higher than that of the first roller 40 to the intermediate transfer belt (image carrying member) 8. The linear speed ratio of the second roller 41 to the intermediate transfer belt (image carrying member) 8 is calculated by the expression (linear rotational speed of the second roller 41) / (linear speed of the intermediate transfer belt 8). The linear speed ratio of the first roller 40 to the intermediate transfer belt (image carrying member) 8 is calculated by the expression (linear rotational speed of the first roller 40) / (linear speed of the intermediate transfer belt 8).

A transfer voltage with the opposite polarity (here, negative polarity) to that of toner is applied to the second roller 41 by the transfer voltage power supply 74 (see FIG. 8). Specifically, when the second roller 41 is disposed at the position shown in FIG. 13, the transfer voltage is applied to it via the second bearing member 45, which is electrically connected to the transfer voltage power supply 74.

The first light-blocking plate 51a on the shaft 51 blocks light to the detection portion of (keeps on) the first position detection sensor S1 and the second light-blocking plate 47d on the roller holder 47 is retracted from the detection portion of (keeps off) the second position detection sensor S2. This state (S1 on/S2 off) is taken as the reference position (home position) of the second roller 41. That is, a shift from the detection state in FIG. 12 (S1/S2 off) to the detection state in FIG. 13 (S1 on/S2 off) permits the detection of the movement of the second roller 41 to the reference position. Based on the rotational time of the switching cam 50 from this reference position, the rotational angle of the switching cam 50 is regulated to control the position and separated state of the second roller 41.

If the second roller 41 is kept in pressed contact with the driving roller 10 for a long time, the second roller 41 may deform by warping along its axial direction. To cope with that, after a job is complete, it is necessary to keep the second roller 41 away from the intermediate transfer belt 8 (driving roller 10). For that purpose, the shaft 51 is rotated counterclockwise and the separated state shown in FIG. 12 is taken.

When calibration is performed during the use of the second roller 41, the second roller 41 is kept in the separated state to prevent a reference image formed on the intermediate transfer belt 8 from adhering to the second roller 41. Furthermore, when calibration is performed with the second roller 41 in the separated state, the reference image can be formed in a middle part of the intermediate transfer belt 8 along the width direction.

At this time, the first light-blocking plate 51a on the shaft 51 retracts from the detection portion of (turns off) the first position detection sensor S1 and the second light-blocking plate 47d on the roller holder 47 stays retracted from the detection portion of (keeps off) the second position detection sensor S2. That is, a shift from the detection state in FIG. 13 (S1 on/S2 off) to the detection state in FIG. 12 (S1/S2 off) permits the detection of the movement of the second roller 41 from the reference position to the separated state.

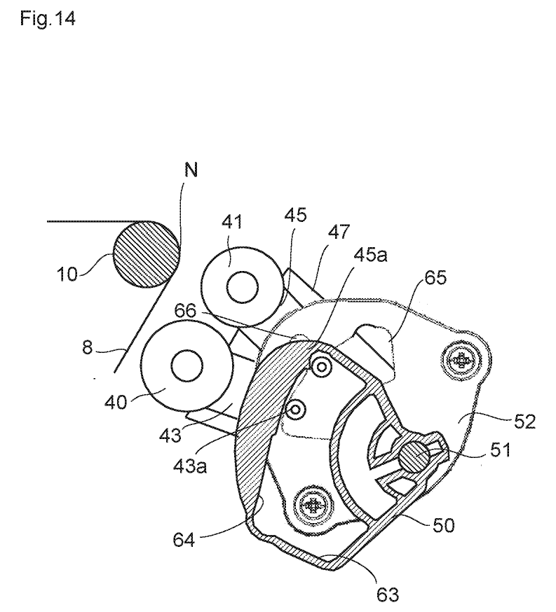

Next, a description will be given of the procedure for switching the roller forming the secondary transfer nip portion N from the second roller 41 to the first roller 40. FIG. 14 is a diagram showing a state where, from the state in FIG. 13, the switching cam 50 has been rotated counterclockwise by a predetermined angle. As the shaft 51 is rotated counterclockwise, together with it, the switching cam 50 also rotates counterclockwise. On the other hand, the roller holder 47 is restrained from rotating counterclockwise by the restricting rib 9c (see FIG. 5). As a result, the second engaging portion 45a moves from the bottom part of the depressed portion 64 to an end of the first guide hole 63 at the other side (the right side in FIG. 13) along the circumferential direction.

At this time, the first engaging portion 43a has moved out of the depressed portion 64 and is disengaged from the positioning groove 66. The second engaging portion 45a has also moved out of the depressed portion 64 and is disengaged from a cam positioning depressed portion 69.

Next, as the shaft 51 is rotated clockwise, together with it, the switching cam 50 also rotates clockwise. Meanwhile, the roller holder 47 also rotates clockwise by a predetermined angle. When the shaft 51 is rotated further clockwise, the roller holder 47 makes contact with the restricting rib 9b (see FIG. 5) and is restrained from rotating clockwise. As a result, the first and second engaging portions 43a and 45a move into the depressed portion 64 and the first engaging portion 43a engages with the positioning groove 66. This results in the state in FIG. 9 in which the first roller 40 is disposed at the reference position. After that, the above procedure is repeated to switch between the first and second rollers 40 and 41.

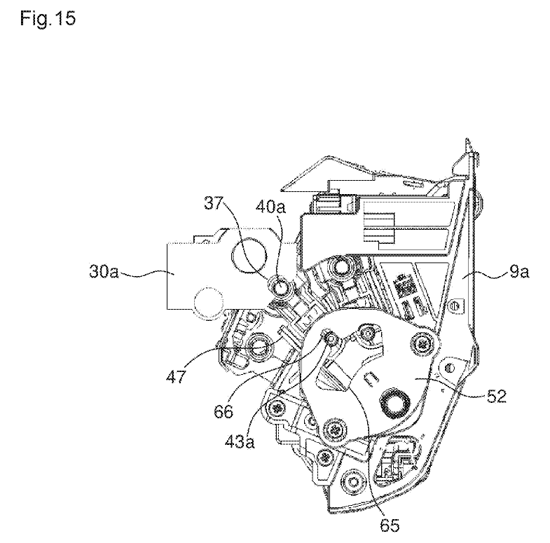

FIG. 15 is a side view showing a state where the metal base 40a of the first roller 40 disposed at the reference position, where it forms the secondary transfer nip portion N, is fitted into a shaft holding portion 37 of the intermediate transfer unit 30. The shaft holding portions 37 are formed on a pair of side frames 30a that supports opposite end parts of the driving roller 10 and primary transfer rollers 6a to 6d in the intermediate transfer unit 30. FIG. 15 only illustrates the side frame 30a and the shaft holding portion 37 at one side.

The shaft holding portion 37 holds opposite end parts of either the metal base 40a of the first roller 40 or the metal base 41a of the second roller 41 disposed at the reference position. This permits the first and second rollers 40 and 41 to be accurately positioned at the reference position.

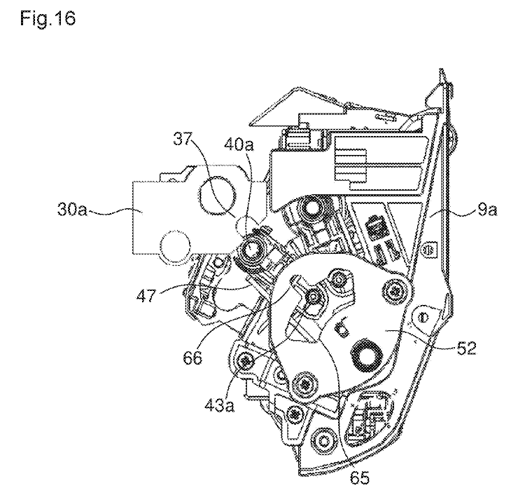

FIG. 16 is a side view showing a state where the first engaging portion 43a of the first bearing member 43 is not engaged with the positioning groove 66 in the fixed cam 52 and the metal base 40a of the first roller 40 is displaced from the shaft holding portion 37. As shown in FIG. 16, when the roller disposed at the reference position is switched to the first roller 40, the roller holder 47 may move downward under the self weight of the first roller 40 and the roller holder 47, and the metal base 40a may not fit into the shaft holding portion 37 of the intermediate transfer unit 30. As a result, the first roller 40 may not be positioned accurately at the reference position to form the secondary transfer nip portion N properly.

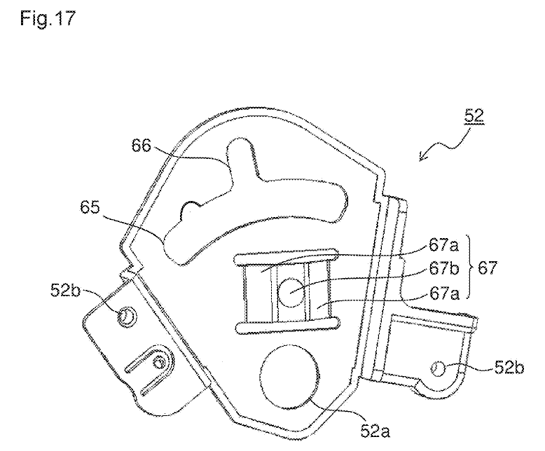

FIG. 17 is a perspective view of the fixed cam 52 used in the secondary transfer unit 9 of the embodiment, as seen from the side facing the roller holder 47. The fixed cam 52 is formed of a resin material. As shown in FIG. 17, on the surface of the fixed cam 52 facing the roller holder 47, a holder positioning protruding portion 67 is integrally formed.

The holder positioning protruding portion 67 is formed between the through hole 52a and the second guide hole 65. The holder positioning protruding portion 67 is, as seen from a side, in the shape of a trapezoid with a pair of inclined surfaces 67a that inclines along the rotational direction of the roller holder 47 (left-right direction in FIG. 17). A hemispherical projection 67b is formed between the pair of inclined surfaces 67a (at a top part of the holder positioning protruding portion 67).

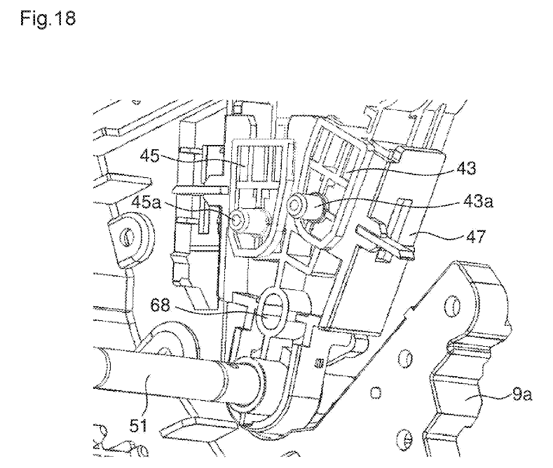

FIG. 18 is a perspective view of the roller holder 47 used in the secondary transfer unit 9 of the embodiment, as seen from its side facing the fixed cam 52. As shown in FIG. 18, the roller holder 47 has a holder positioning depressed portion 68 formed in its surface facing the fixed cam 52. The holder positioning depressed portion 68 is in the shape of an ellipse that is elongate along the radial direction (top-bottom direction in FIG. 18) orthogonal to the rotational direction of the roller holder 47. The outer diameter of the projection 67b (see FIG. 17) on the holder positioning protruding portion 67 is slightly larger than the inner diameter of the holder positioning depressed portion 68 along the rotational direction of the roller holder 47 (horizontal direction in FIG. 18).

When the first roller 40 is disposed at the reference position, rotating the shaft 51 clockwise from the state in FIG. 14 results in the state in FIG. 9 where the first roller 40 faces the driving roller 10. Meanwhile, the roller holder 47 moves while running over the inclined surface 67a of the holder positioning protruding portion 67 formed on the fixed cam 52.

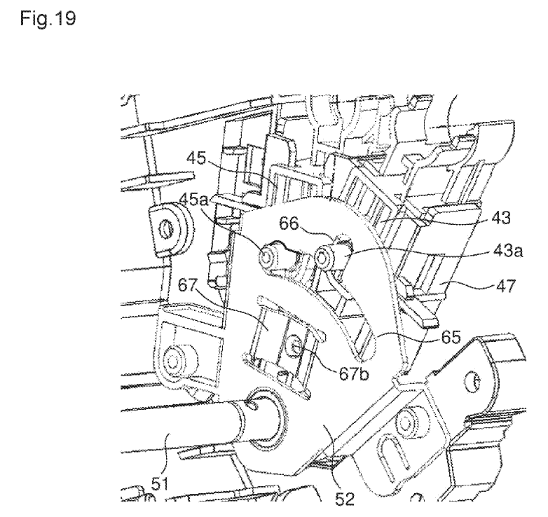

FIG. 19 is a perspective view of a state where the holder positioning protruding portion 67 on the fixed cam 52 is engaged with the holder positioning depressed portion 68 in the roller holder 47, as seen from radially inward. When the roller holder 47 has moved into the state in FIG. 9, the first engaging portion 43a engages with the positioning groove 66 in the fixed cam 52. The second engaging portion 45a engages with the cam positioning depressed portion 69 in the fixed cam 52. The projection 67b on the holder positioning protruding portion 67 engages with the holder positioning depressed portion 68 in the roller holder 47. Here, since the outer diameter of the projection 67b is slightly larger than the inner diameter of the holder positioning depressed portion 68, the projection 67b is held in a state where it is slightly sunk in the holder positioning depressed portion 68.

With the configuration of the embodiment, with a simple configuration using the roller holder 47 and the switching cam 50, either the first roller 40 or the second roller 41 can be disposed so as to face the driving roller 10, and one of these rollers disposed to face the driving roller 10 can be disposed selectively either at the reference position where it forms the secondary transfer nip portion N or at the separated position where it stays away from the intermediate transfer belt 8.

Furthermore, the control portion 90 rotates the roller holder 47 according to the thickness or basis weight of the sheet (recording medium) S to dispose either the first roller 40 or the second roller 41 so that it faces the intermediate transfer belt (image carrying member) 8.

Specifically, when a print job is input to the operation portion 80, based on the type of the selected sheet S, the control portion 90 reads out the corresponding basis weight or thickness, which is previously stored in the storage portion.

At this time, for example, if the basis weight of the sheet S is more than a predetermined threshold value (130 g/m²), the second roller 41 is disposed at the reference position. For another example, if the basis weight of the sheet S is equal to or less than the predetermined threshold value (130 g/m²), the first roller 40 is disposed at the reference position. The second roller 41 has a higher linear speed ratio to the intermediate transfer belt (image carrying member) 8 than the first roller 40. The outer diameter of the metal base 41a of the second roller 41 is larger than that of the metal base 40a of the first roller 40. Furthermore, the outer diameter of the elastic layer 41b of the second roller 41 is larger than that of the elastic layer 40b of the first roller 40. The second roller 41 is urged toward the intermediate transfer belt (image carrying member) 8 by the second coil spring 49 which has a spring load higher than that of the first coil spring 48.

This helps suppress an increase in the conveying load during passage through the secondary transfer nip portion (transfer nip portion) N. It is thus possible to alleviate, according to the type (thickness or basis weight) of the sheet (recording medium), conveying streaks and friction against the intermediate transfer belt 8 and thereby suppress transfer failure.

If the thickness of the sheet S is more than the predetermined threshold value, the second roller 41 is disposed at the reference position. If the thickness of the sheet S is equal to or less than the predetermined threshold value, the first roller 40 may be disposed at the reference position.

It is also possible to determine, based on a combination of the basis weight or thickness and the width of a sheet S, which of the first and second rollers 40 and 41 to dispose at the reference position.

The embodiment described above is not meant to limit the scope of the present disclosure, which thus allows for any modifications without departure from the spirit of what is disclosed herein. For example, the shapes, dimensions, and the like of the first roller 40, the second roller 41, the roller holder 47, the switching cam 50, the fixed cam 52, and the like constituting the secondary transfer unit 9 are examples and thus can be modified as desired within the scope that does not impair the effects of the present disclosure.

For example, in the embodiment, the second roller 41 has a higher linear speed ratio to the intermediate transfer belt (image carrying member) 8 than the first roller 40. Furthermore, the outer diameter of the metal base 41a of the second roller 41 is larger than that of the metal base 40a of the first roller 40. The outer diameter of the elastic layer 41b of the second roller 41 is larger than that of the elastic layer 40b of the first roller 40. The second roller 41 is urged toward the intermediate transfer belt (image carrying member) 8 by the second coil spring 49 which has a spring load higher than that of the first coil spring 48. However, it may have only one of these elements.

That is, the first and second rollers 40 and 41 may have the same shape and only differ in the linear speed ratio to the intermediate transfer belt (image carrying member) 8.

For example, the linear speed ratio of the second roller 41 to the intermediate transfer belt (image carrying member) 8 may be set to be higher than that of the first roller 40 to the intermediate transfer belt (image carrying member) 8, and the outer diameter of the metal base 41a of the second roller 41 may be set to be equal to that of the metal base 40a of the first roller 40. The outer diameter of the elastic layer 41b of the second roller 41 may also be set to be equal to that of the elastic layer 40b of the first roller 40.

Although, in the embodiment, the first and second rollers 40 and 41 do not move by following the driving roller 10, either of them may be made to move by following the driving roller 10. In that case, the other of the first and second rollers 40 and 41, which does not move by following the driving roller 10, may be driven separately from the driving roller 10 or may be connected to the driving roller 10 via a gear.

While the embodiment described above deals with, as an example, an intermediate transfer type image forming apparatus 100 provided with a secondary transfer unit 9 that secondarily transfers to a sheet S a toner image primarily transferred to the intermediate transfer belt 8, the present disclosure is applicable equally to a transfer unit incorporated in a direct transfer type image forming apparatus that directly transfers to a sheet a toner image formed on a photosensitive drum.

While the embodiment described above deals with an example where toner images of different colors are formed by a plurality of image forming portions Pa to Pd, the image forming apparatus 100 may instead be a monochrome device that forms a single color toner image with one image forming portion.

The present disclosure is applicable to an image forming apparatus provided with a transfer unit that transfers a toner image formed on an image carrying member to a recording medium. According to the present disclosure, it is possible to provide a transfer unit that can improve the positional accuracy, and the smoothness of switching operation, of two rollers of which one is selectively pressed against an image carrying member when they are switched, and to provide an image forming apparatus provided with such a transfer unit.

What is claimed is:

1. A transfer unit comprising:
a transfer roller having a metal base and an elastic layer laid on an outer circumferential surface of the metal base, the transfer roller forming a transfer nip portion by pressing the elastic layer against an image carrying member, the transfer unit that transfers a toner image formed on the image carrying member to a recording medium passing through the transfer nip portion,
wherein
the transfer roller includes a first roller and a second roller different from the first roller,
whichever of the first and second rollers is disposed to face the image carrying member is disposed selectively either at a reference position where the first or second transfer roller forms the transfer nip portion by being pressed against the image carrying member or at a separated position where the first or second roller stays away from the image carrying member, and
either the first or second roller is disposed to face the image carrying member according to a thickness or a basis weight of the recording medium.

2. The transfer unit according to claim 1, wherein
a linear speed ratio of the second roller to the image carrying member is higher than a linear speed ratio of the first roller to the image carrying member,
if the basis weight of the recording medium is more than a predetermined threshold value, the second roller is disposed so as to face the image carrying member, and
if the basis weight of the recording medium is equal to or less than the predetermined threshold value, the first roller is disposed so as to face the image carrying member.

3. The transfer unit according to claim 1, wherein
an outer diameter of the elastic layer of the second roller is larger than an outer diameter of the elastic layer of the first roller.

4. The transfer unit according to claim 1, further comprising:
a first bearing member that rotatably supports the first roller;
a second bearing member that rotatably supports the second roller;
a roller holder that has first and second bearing holding portions respectively holding the first and second bearing members so that the first and second bearing members can slide toward and away from the image carrying member;
a first urging member disposed between the first bearing holding portion and the first bearing member, the first urging member urging the first bearing member toward the image carrying member;
a second urging member disposed between the second bearing holding portion and the second bearing member, the second urging member urging the second bearing member toward the image carrying member;
a switching cam that has a first guide hole with which a first engaging portion formed on the first bearing member and a second engaging portion formed on the second bearing member engage;
a driving mechanism that drives the roller holder and the switching cam to rotate;
a control portion that controls the driving mechanism;
a unit frame that rotatably supports the roller holder and the switching cam; and
a fixed cam fixed to the unit frame,
wherein
the control portion rotates the switching cam to change an engagement position of the first and second engaging portions in the first guide hole so that whichever of the first and second rollers is disposed to face the image carrying member is disposed selectively either at the reference position or at the separated position,
a spring load of the second urging member is higher than a spring load of the first urging member,
an outer diameter of the metal base of the second roller is larger than an outer diameter of the metal base of the first roller, and
if the basis weight of the recording medium is more than the predetermined threshold value, the control portion disposes the second roller so that the second roller faces the image carrying member.

5. A transfer unit comprising:
a transfer roller having a metal base and an elastic layer laid on an outer circumferential surface of the metal base, the transfer roller forming a transfer nip portion by pressing the elastic layer against an image carrying member, the transfer unit that transfers a toner image formed on the image carrying member to a recording medium passing through the transfer nip portion,
wherein
the transfer roller includes a first roller and a second roller having a different linear speed ratio from a linear speed ratio of the first roller,
whichever of the first and second rollers is disposed to face the image carrying member is disposed selectively either at a reference position where the first or second transfer roller forms the transfer nip portion by being pressed against the image carrying member or at a separated position where the first or second roller stays away from the image carrying member, and
either the first or second roller is disposed to face the image carrying member according to a type of the recording medium.

6. An image forming apparatus comprising:
an image forming portion that forms the toner image;
an endless intermediate transfer belt that moves along the image forming portion, the intermediate transfer belt serving as the image carrying member;
a primary transfer member disposed so as to face a photosensitive drum disposed in the image forming portion across the intermediate transfer belt, the primary transfer member primarily transferring to the intermediate transfer belt the toner image formed on the photosensitive drum; and
the transfer unit according to claim 1 as a secondary transfer unit that secondarily transfers to the recording medium the toner image primarily transferred to the intermediate transfer belt.
